(19) United States
(12) Patent Application Publication
(10) Pub. No.: US 2004/0208735 A1
(43) Pub. Date: Oct. 21, 2004

(54) Multiple implement track slide system

(76) Inventor: Robert E. DePue, Savannah, GA (US)

Correspondence Address: ROBERT E. DEPUE, 412 BONAVENTURE RD., SAVANNAH, GA, 31404, US

(21) Appl. No.: 10/418,869

(22) Filed: Apr. 21, 2003

(51) Int. Cl. B66F 1/00

(52) U.S. Cl. 414/607

(57) ABSTRACT

An elongated, elongatable frame attachable at one end to a motorized lifting device of the nature of a “Good Buddy” and the other end containing hitch units for attaching utilitarian implements to the frame.

### BACKGROUND OF THE INVENTION

There exists as part of the prior art in the funeral and burial vault business, a wheel mounted, portable motorized lift device commonly known as a “Good Buddy”. It is mounted on wheels and connects to a burial vault or coffin for transportation to a gravesite and lowering into the grave. To the best of knowledge of the applicant, the Good Buddy device has not been patented and is in widespread use in the funeral industry. The slide system of the present invention attaches to the lower frame of the Good Buddy and includes means for attaching thereto a variety of utilitarian construction implements such as a backhoe, front-end loader, trencher, conveyor, hauling hopper, well drilling device, etc. The purpose of my invention is to provide means for easily attaching any of these utilitarian devices to the easily portable Good Buddy.

The following list of typical utilitarian construction devices which can be attached to a Good Buddy or similar motorized, portable burial vault lifting and transporting device by my invention:

Backhoe

Front End Loader

Trencher

Concrete Bucket

Tipping Sand or Dirt Bucket

Flexible Pipe or Wire Reel

Horizontal Rail Crane

Jack Boom Crane

Pavement Breaker

Pile Driver

Auger, Vertical or Horizontal

Well Drilling Attachment

Conveyor, Wet or Dry

Cement or Mortar Mixer

Hauling Hopper

Another advantage of my invention is that, once attached to the Good Buddy, any or all of these industrial implements may be attached to the front or the rear end of the Good Buddy. Still another advantage of my invention is that one construction implement could be attached to the front end of the Good Buddy for construction purpose while simultaneously another industrial construction implement could be attached to the rear of the Good Buddy for simultaneous use at the same construction site, or nearby construction site. Any or all of the construction implements can be attached, detached, and/or re-attached with ease of assembly before, during or after transportation of the Good Buddy to the grave or construction site.

### BRIEF DESCRIPTION OF THE DRAWINGS

FIG. 1 is a perspective view of the Multiple implement Track Slide System of my invention positioned below an unsupported Good Buddy.

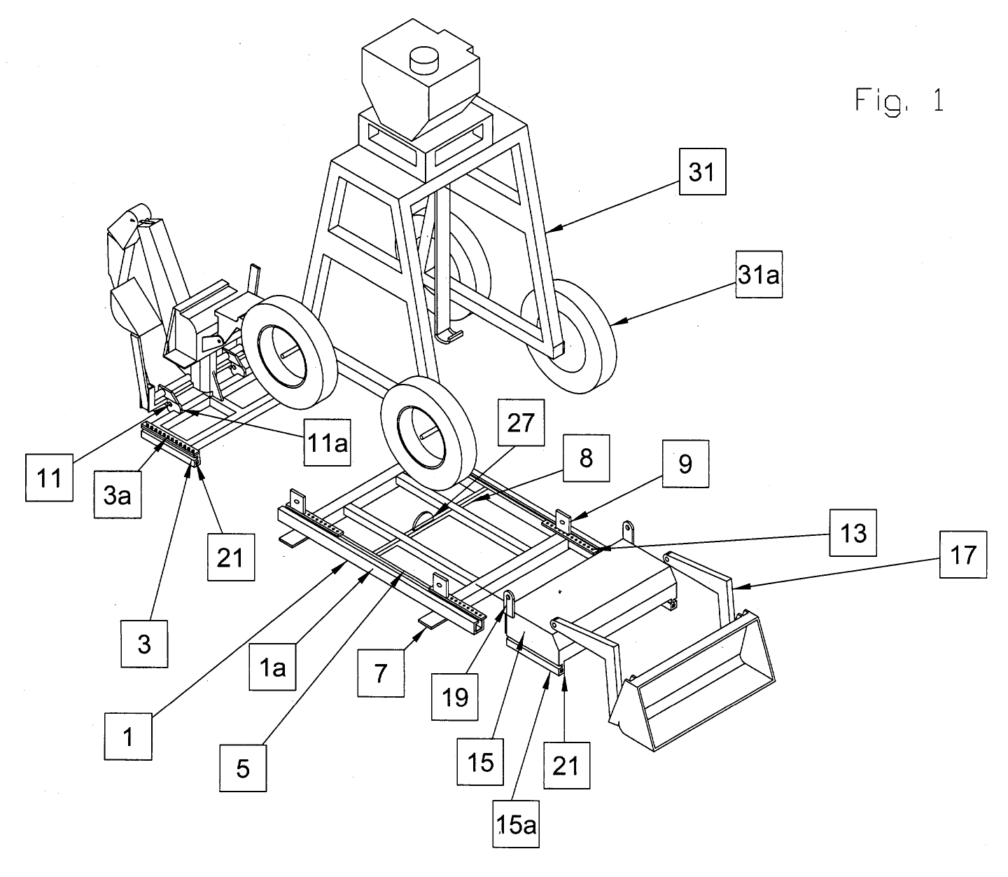

FIG. 2 is a perspective view of the rear portion of the Track Slide System of my invention attached to, within and below, the frame of a Good Buddy.

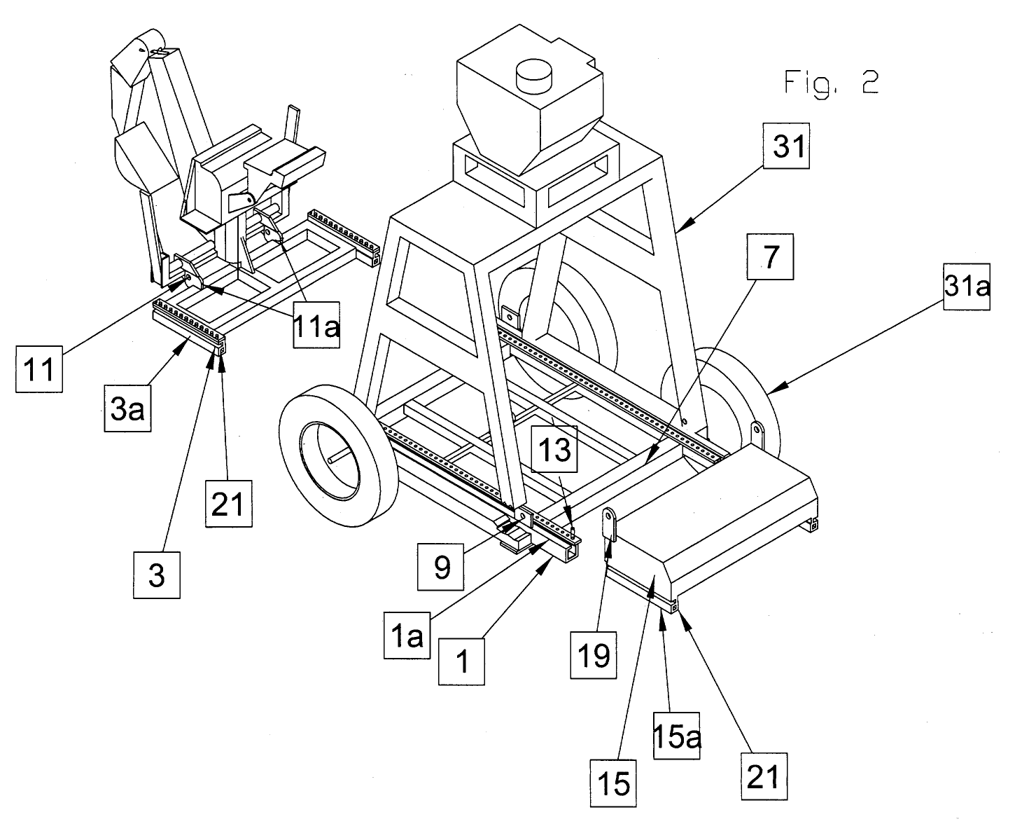

### DETAILED DESCRIPTION OF THE INVENTION

Referring to the drawings, the invention comprises three primary elements. The first is an elongated, rectangularly shaped frame structure (1) having a pair of facing parallel flange track slides (1a).

The second primary element comprises a three point hitch implement assembly (11) supported on a smaller rectangular steel frame (3) having a pair of facing parallel slide tracks (3a) designed to slide into the parallel side slides (1a) of the primary track frame (1). The three point hitch assembly (11) has permanently welded or otherwise attached a standard three point hitch (11a) for attaching constructural industrial implements of the nature listed in the first portion of this application.

The third primary element comprises a counterweight assembly (15) supported over a pair of parallel track slides (15a) configured to slide into the side track slides (1a) of the track frame (1). The purpose of the counterweight assembly (15) is to provide a counterweight to any industrial utilitarian device attached to the other end of the track frame (1) to avoid its tipping and provide means for attaching industrial utilitarian implements to the other end of the track frame (1), such as a loader assembly (17). The track slides (3) of the hitch assembly (11) and (15a) of the counterweight assembly (15) have Teflon slide bushings (21) for ease of assembly. Assembly locking pins (13) inserted into a locking strap (5) overlying the track slide frames (1a), hitch assembly slide frames (3a) and counterweight slide frames (15a) lock the hitch assembly (11) and the counterweight assembly (15) in place. Any industrial construction implement with a standard three-point hitch can be attached to the track slide (3) at either end of the track frame (1). The track frame (1) has a locking strap (5) for attaching the three point hitch assembly (11) to the track frame (1) by sliding the track slide (3) into the locking strap (5) and held in place by locking pins (13).

The counterweight assembly (15) also has track slides (15a) with which to mount the counterweight assembly (15) onto the track frame (1). Locking pins (13) lock the track slides (3) onto the front of track frame (1), lock the counterweight assembly (15) onto the rear of track frame (1), or mount a utilitarian device, such as a steel hopper (21), or any other implement having a standard three point hitch onto the hitch assembly (11). The counterweight assembly (15) also has mounting flanges (19) for attaching another industrial implement such as a front-end loader implement (17). A cross arm (8) of the track frame (1) has a lifting mounting (27) to which a lifting strap is attached to the winch on the Good Buddy (31) for lifting the track frame (1) into place within the Good Buddy (31). The mountings (9) secure the track frame (1) to the bottom frame of the Good Buddy and hold the positioning flanges (7) in place.

A second embodiment of my invention would comprise one primary element instead of three, in that the three point hitch assembly (11) and the counterweight assembly (15) could both be permanently welded to the track frame (1). This secondary embodiment would still allow for easy attachment of all the same industrial construction devices that are attachable to the preferred embodiment of my invention.

1. What I am claiming is an elongated frame structure attachable to a motorized lifting device of the nature of a “Good Buddy” comprising a pair of elongated frame structures each having a pair of facing parallel arranged flanged sides in which the flanged sides of each of said pair are designed to slide within each other and one of said pair supports a three point hitch implement assembly unit and a second of said pair having means for attachment to the frame of said motorized lifting device.
